(19) United States
(12) Patent Application Publication
(10) Pub. No.: US 2025/0094783 A1
(43) Pub. Date: Mar. 20, 2025

(54) INFERENCE VERIFICATION SYSTEM AND INFERENCE VERIFICATION METHOD

(71) Applicant: Mitsubishi Electric Corporation, Tokyo (JP)

(72) Inventors: Yutaro NISHIDA, Tokyo (JP); Satoshi YASUDA, Tokyo (JP); Yoshihiro KOSEKI, Tokyo (JP); Goichiro HANAOKA, Tokyo (JP); Nuttapong ATTRAPADUNG, Tokyo (JP); Yusuke SAKAI, Tokyo (JP); Jacob Chroeis Nakamura SCHULDT, Tokyo (JP)

(73) Assignee: Mitsubishi Electric Corporation, Tokyo (JP)

(21) Appl. No.: 18/966,341

(22) Filed: Dec. 3, 2024

Related U.S. Application Data
(63) Continuation of application No. PCT/JP2022/026498, filed on Jul. 1, 2022.

(51) Int. Cl. G06N 3/0464

(52) U.S. Cl. CPC G06N 3/0464

(57) ABSTRACT

An inference device (400) obtains an inference result by executing an inference model by expressing a decimal value that is data on which inference processing is to be performed as an integer value and treating the integer value as a parameter of a convolutional neural network. A proving device (500) obtains a proof by executing a proof generation algorithm using the inference result as input. A verification device (600) obtains a verification result by executing a verification algorithm using the proof as input.

### CROSS REFERENCE TO RELATED APPLICATION

This application is a Continuation of PCT International Application No. PCT/JP2022/026498, filed on Jul. 1, 2022, which is hereby expressly incorporated by reference into the present application.

### TECHNICAL FIELD

The present disclosure relates to verification of an inference model using zero-knowledge proofs.

### BACKGROUND ART

AI inference techniques using neural networks have been used with great success in machine learning tasks such as data classification. AI is an abbreviation for artificial intelligence.

In order to perform data analysis using a neural network, it is necessary to train an inference model using a large amount of training data in advance. At this time, it may be difficult for a user to build an inference model in the user's own environment due to the difficulty of preparing training data, constraints of computational resources, and so on.

In this context, in recent years, there have been services that provide data analysis using neural networks on a cloud (MLaaS). These services allow clients to perform inference using provided inference models by uploading data to be analyzed onto the cloud. Therefore, the clients do not need to incur costs in building inference models.

MLaaS is an abbreviation for machine learning as a service.

In MLaaS, when a client sends data to be analyzed and entrusts inference processing to a provider of an inference model, the service provider needs to prove to the client that an inference result is actually a result of analysis performed by the inference model.

The simplest solution is for the service provider to publish the inference model itself. However, since the inference model is the intellectual property of the service provider, it is difficult to disclose the inference model to the client.

Non-Patent Literature 1 proposes a method that makes it possible to prove, using a zero-knowledge proof, that inference processing using an inference model has been actually performed.

This method allows the service provider to prove to the client that the inference result has been obtained by analysis processing by the inference model.

### CITATION LIST

### Non-Patent Literature

Non-Patent Literature 1: zkCNN: Zero Knowledge Proofs for Convolutional Neural Network Predictions and Accuracy. Tianyi Liu, Xiang Xie, and Yupeng Zhang. 2021.

### SUMMARY OF INVENTION

### Technical Problem

The method of Non-Patent Literature 1 can only handle integer values as parameters of the inference model due to constraints of protocols for zero-knowledge proofs that are used.

An object of the present disclosure is to make it possible to verify an inference model whose parameters are decimals.

### Solution to Problem

An inference verification system according to the present disclosure includes an inference unit to obtain an inference result by executing an inference model by expressing a decimal value that is data on which inference processing is to be performed as an integer value and treating the integer value as a parameter of a convolutional neural network;
a proving unit to obtain a proof by executing a proof generation algorithm using the inference result as input; and
a verification unit to obtain a verification result by executing a verification algorithm using the proof as input.

### Advantageous Effects of Invention

According to the present disclosure, an inference model whose parameters are decimals can be verified.

### BRIEF DESCRIPTION OF DRAWINGS

FIG. 1 is a configuration diagram of an inference verification system 100 in Embodiment 1;

FIG. 2 is a configuration diagram of a parameter generation device 200 in Embodiment 1;

FIG. 3 is a configuration diagram of a key generation device 300 in Embodiment 1;

FIG. 4 is a configuration diagram of an inference device 400 in Embodiment 1;

FIG. 5 is a configuration diagram of a proving device 500 in Embodiment 1;

FIG. 6 is a configuration diagram of a verification device 600 in Embodiment 1;

FIG. 7 is a flowchart of an inference verification method (parameter generation) in Embodiment 1;

FIG. 8 is a flowchart of the inference verification method (key generation) in Embodiment 1;

FIG. 9 is a flowchart of the inference verification method (inference) in Embodiment 1;

FIG. 10 is a flowchart of the inference verification method (proving) in Embodiment 1;

FIG. 11 is a flowchart of the inference verification method (verification) in Embodiment 1;

FIG. 12 is a hardware configuration diagram of the parameter generation device 200 in Embodiment 1;

FIG. 13 is a hardware configuration diagram of the key generation device 300 in Embodiment 1;

FIG. 14 is a hardware configuration diagram of the inference device 400 in Embodiment 1;

FIG. 15 is a hardware configuration diagram of the proving device 500 in Embodiment 1; and

FIG. 16 is a hardware configuration diagram of the verification device 600 in Embodiment 1.

### DESCRIPTION OF EMBODIMENTS

In the embodiment and drawings, the same elements or corresponding elements are denoted by the same reference sign. Description of an element denoted by the same reference sign as that of an element that has been described will be omitted or simplified as appropriate. Arrows in figures mainly indicate flows of data or flows of processing.

### Embodiment 1

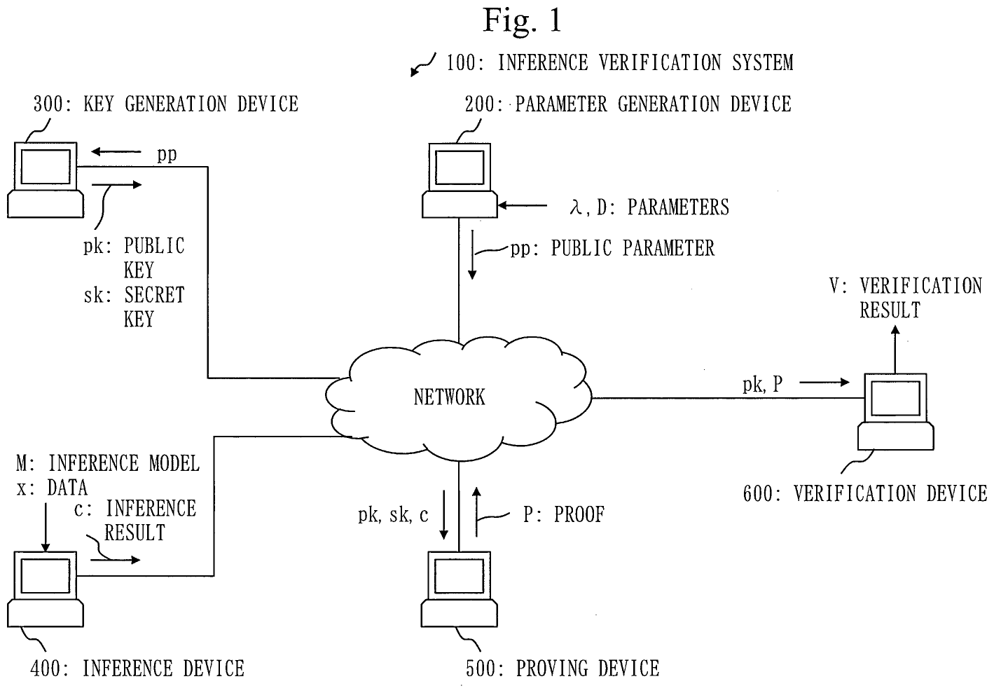

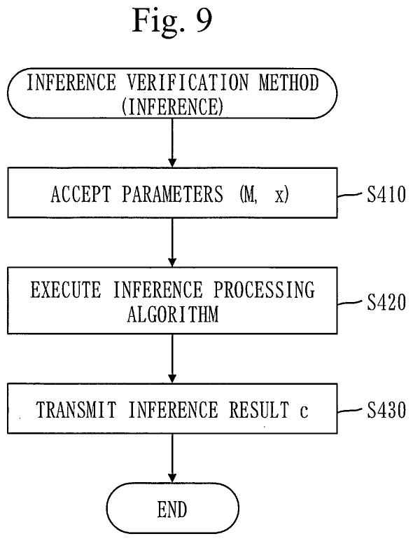

An inference verification system 100 will be described based on FIGS. 1 to 16.

The inference verification system 100 is a system that can verify inference processing.

### Description of Configurations

Based on FIG. 1, a configuration of the inference verification system 100 will be described.

The inference verification system 100 includes devices such as a parameter generation device 200, a key generation device 300, an inference device 400, a proving device 500, and a verification device 600.

There devices communicate with one another through a network. A specific example of the network is the Internet.

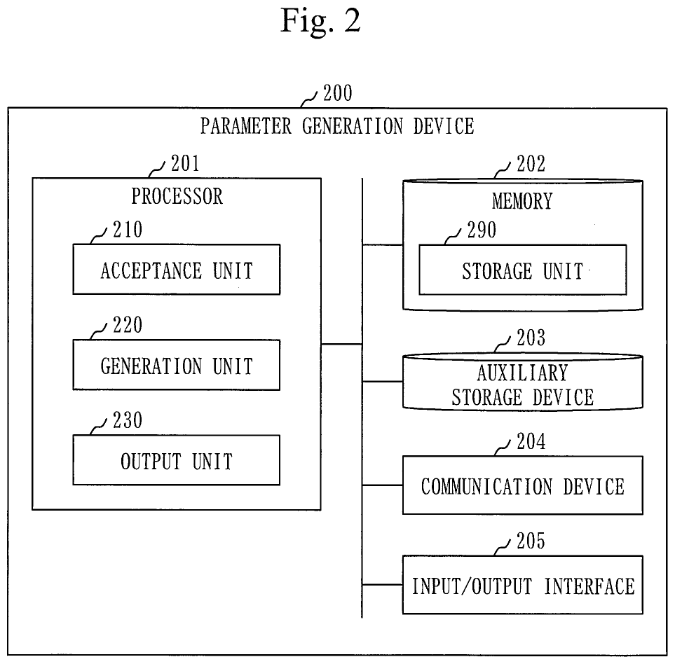

Based on FIG. 2, a configuration of the parameter generation device 200 will be described.

The parameter generation device 200 is a computer that includes hardware such as a processor 201, a memory 202, an auxiliary storage device 203, a communication device 204, and an input/output interface 205. These hardware components are connected with one another through signal lines.

The processor 201 is the processor of the parameter generation device 200.

The processor is an IC that performs operational processing and controls other hardware components. For example, the processor is a CPU.

IC is an abbreviation for integrated circuit.

CPU is an abbreviation for central processing unit.

The memory 202 is the memory of the parameter generation device 200.

The memory is a volatile or non-volatile storage device. The memory is also called a main storage device or a main memory. For example, the memory is a RAM.

Data stored in the memory 202 is saved in the auxiliary storage device 203 as necessary.

RAM is an abbreviation for random access memory.

The auxiliary storage device 203 is the auxiliary storage device of the parameter generation device 200.

The auxiliary storage device is a non-volatile storage device. For example, the auxiliary storage device is a ROM, an HDD, a flash memory, or a combination of these.

Data stored in the auxiliary storage device 203 is loaded into the memory 202 as necessary.

ROM is an abbreviation for read only memory.

HDD is an abbreviation for hard disk drive.

The communication device 204 is the communication device of the parameter generation device 200.

The communication device is a receiver and a transmitter. For example, the communication device is a communication chip or a NIC.

Communication of the parameter generation device 200 is performed using the communication device 204.

NIC is an abbreviation for network interface card.

The input/output interface 205 is the input/output interface of the parameter generation device 200.

The input/output interface is a port to which an input device and an output device are connected. For example, the input/output interface is a USB terminal, the input device is a keyboard and a mouse, and the output device is a display.

Input to and output from the parameter generation device 200 is performed using the input/output interface 205.

USB is an abbreviation for Universal Serial Bus.

The parameter generation device 200 includes elements such as an acceptance unit 210, a generation unit 220, and an output unit 230. These elements are realized by software.

The auxiliary storage device 203 stores a parameter generation program to cause a computer to function as the acceptance unit 210, the generation unit 220, and the output unit 230. The parameter generation program is loaded into the memory 202 and executed by the processor 201.

The auxiliary storage device 203 further stores an OS. At least part of the OS is loaded into the memory and executed by the processor.

The processor 201 executes the parameter generation program while executing the OS.

OS is an abbreviation for operating system.

Input data and output data of the parameter generation program are stored in a storage unit 290.

The memory 202 functions as the storage unit 290. However, a storage device such as the auxiliary storage device 203, a register in the processor 201, and a cache memory in the processor 201 may function as the storage unit 290 in place of the memory 202 or together with the memory 202.

The parameter generation device 200 may include a plurality of processors as an alternative to the processor 201.

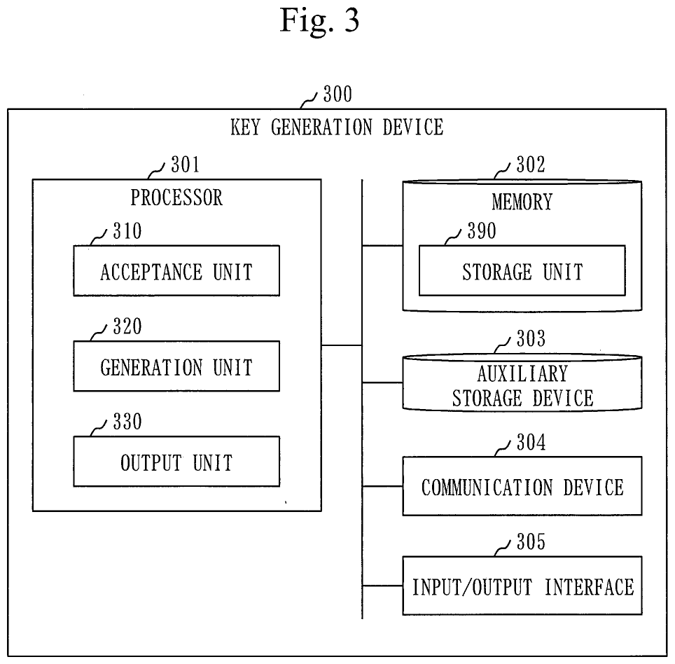

Based on FIG. 3, a configuration of the key generation device 300 will be described.

The key generation device 300 is a computer that includes hardware such as a processor 301, a memory 302, an auxiliary storage device 303, a communication device 304, and an input/output interface 305. These hardware components are connected with one another through signal lines.

The processor 301 is the processor of the key generation device 300.

The memory 302 is the memory of the key generation device 300.

The auxiliary storage device 303 is the auxiliary storage device of the key generation device 300.

The communication device 304 is the communication device of the key generation device 300.

The input/output interface 305 is the input/output interface of the key generation device 300.

The key generation device 300 includes elements such as an acceptance unit 310, a generation unit 320, and an output unit 330. These elements are realized by software.

The auxiliary storage device 303 stores a key generation program to cause a computer to function as the acceptance unit 310, the generation unit 320, and the output unit 330. The key generation program is loaded into the memory 302 and executed by the processor 301.

The key generation device 300 further stores an OS.

The processor 301 executes the key generation program while executing the OS.

Input data and output data of the key generation program are stored in a storage unit 390.

The memory 302 functions as the storage unit 390. However, a storage device such as the auxiliary storage device 303, a register in the processor 301, and a cache memory in the processor 301 may function as the storage unit 390 in place of the memory 302 or together with the memory 302.

The key generation device 300 may include a plurality of processors as an alternative to the processor 301.

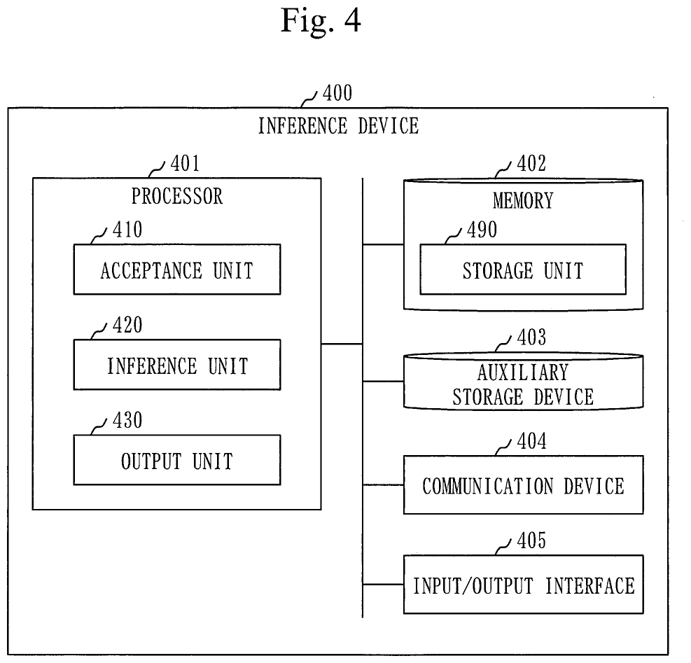

Based on FIG. 4, a configuration of the inference device 400 will be described.

The inference device 400 is a computer that includes hardware such as a processor 401, a memory 402, an auxiliary storage device 403, a communication device 404, and an input/output interface 405. These hardware components are connected with one another through signal lines.

The processor 401 is the processor of the inference device 400.

The memory 402 is the memory of the inference device 400.

The auxiliary storage device 403 is the auxiliary storage device of the inference device 400.

The communication device 404 is the communication device of the inference device 400.

The input/output interface 405 is the input/output interface of the inference device 400.

The inference device 400 includes elements such as an acceptance unit 410, an inference unit 420, and an output unit 430. These elements are realized by software.

The auxiliary storage device 403 stores an inference program to cause a computer to function as the acceptance unit 410, the inference unit 420, and the output unit 430. The inference program is loaded into the memory 402 and executed by the processor 401.

The inference device 400 further stores an OS.

The processor 401 executes the inference program while executing the OS.

Input data and output data of the inference program are stored in a storage unit 490.

The memory 402 functions as the storage unit 490. However, a storage device such as the auxiliary storage device 403, a register in the processor 401, and a cache memory in the processor 401 may function as the storage unit 490 in place of the memory 402 or together with the memory 402.

The inference device 400 may include a plurality of processors as an alternative to the processor 401.

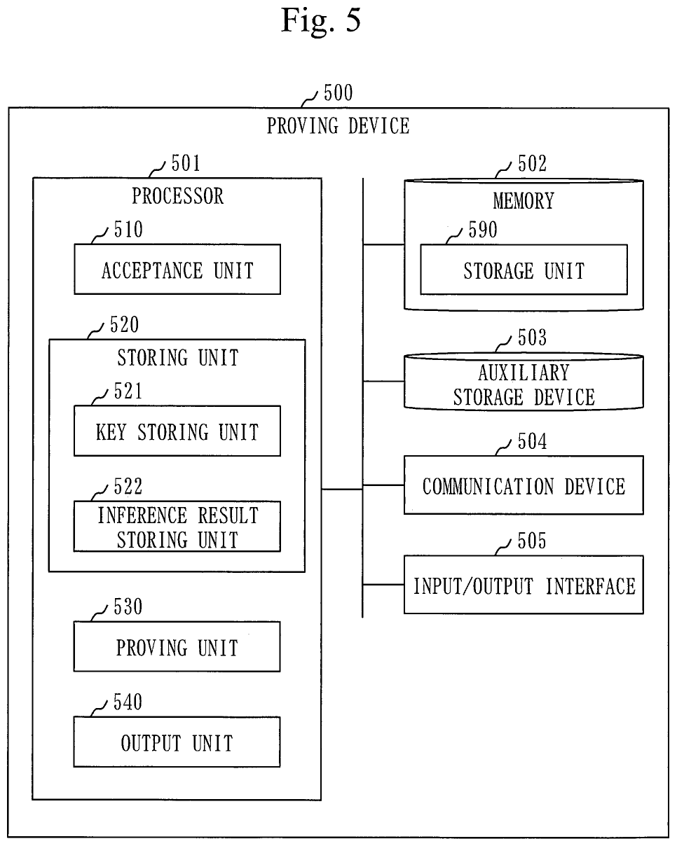

Based on FIG. 5, a configuration of the proving device 500 will be described.

The proving device 500 is a computer that includes hardware such as a processor 501, a memory 502, an auxiliary storage device 503, a communication device 504, and an input/output interface 505. These hardware components are connected with one another through signal lines.

The processor 501 is the processor of the proving device 500.

The memory 502 is the memory of the proving device 500.

The auxiliary storage device 503 is the auxiliary storage device of the proving device 500.

The communication device 504 is the communication device of the proving device 500.

The input/output interface 505 is the input/output interface of the proving device 500.

The proving device 500 includes elements such as an acceptance unit 510, a storing unit 520, a proving unit 530, and an output unit 540. The storing unit 520 includes a key storing unit 521 and an inference result storing unit 522. These elements are realized by software.

The auxiliary storage device 503 stores a proving program to cause a computer to function as the acceptance unit 510, the storing unit 520, the proving unit 530, and the output unit 540. The proving program is loaded into the memory 502 and executed by the processor 501.

The proving device 500 further stores an OS.

The processor 501 executes the proving program while executing the OS.

Input data and output data of the proving program are stored in a storage unit 590.

The memory 502 functions as the storage unit 590. However, a storage device such as the auxiliary storage device 503, a register in the processor 501, and a cache memory in the processor 501 may function as the storage unit 590 in place of the memory 502 or together with the memory 502.

The proving device 500 may include a plurality of processors as an alternative to the processor 501.

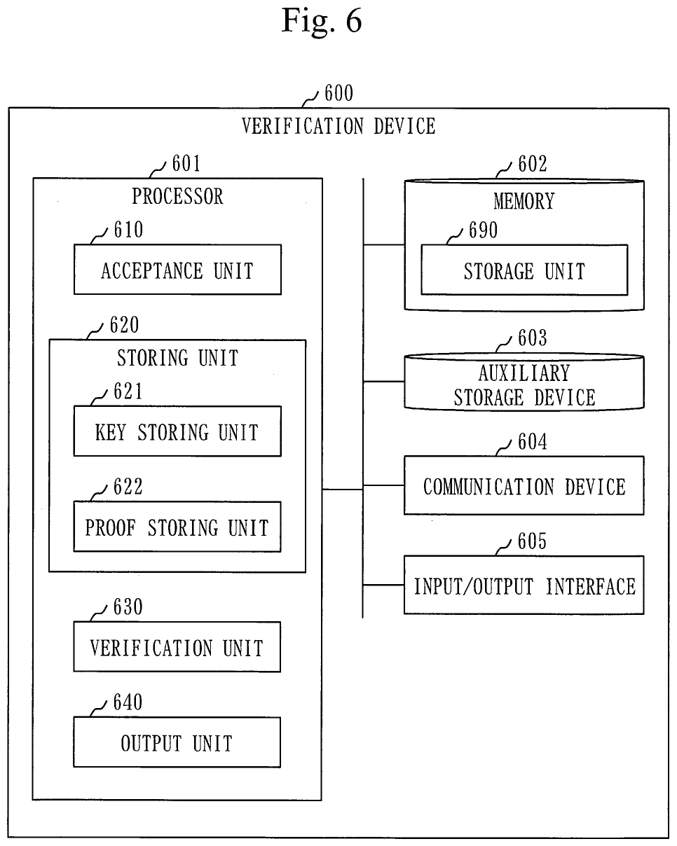

Based on FIG. 6, a configuration of the verification device 600 will be described.

The verification device 600 is a computer that includes hardware such as a processor 601, a memory 602, an auxiliary storage device 603, a communication device 604, and an input/output interface 605. These hardware components are connected with one another through signal lines.

The processor 601 is the processor of the verification device 600.

The memory 602 is the memory of the verification device 600.

The auxiliary storage device 603 is the auxiliary storage device of the verification device 600.

The communication device 604 is the communication device of the verification device 600.

The input/output interface 605 is the input/output interface of the verification device 600.

The verification device 600 includes elements such as an acceptance unit 610, a storing unit 620, a verification unit 630, and an output unit 640. The storing unit 620 includes a key storing unit 621 and a proof storing unit 622. These elements are realized by software.

The auxiliary storage device 603 stores a verification program to cause a computer to function as the acceptance unit 610, the storing unit 620, the verification unit 630, and the output unit 640. The verification program is loaded into the memory 602 and executed by the processor 601.

The verification device 600 further stores an OS.

The processor 601 executes the verification program while executing the OS.

Input data and output data of the verification program are stored in a storage unit 690.

The memory 602 functions as the storage unit 690. However, a storage device such as the auxiliary storage device 603, a register in the processor 601, and a cache memory in the processor 601 may function as the storage unit 690 in place of the memory 602 or together with the memory 602.

The verification device 600 may include a plurality of processors as an alternative to the processor 601.

### Description of Notation

The notation in the following description will be indicated.

When “A” is a distribution, “y←A” denotes that y is randomly selected from A according to that distribution.

When “A” is a set, “y←A” denotes that y is uniformly selected from A for input x.
“p” is any prime number.
“G” is a group of order p.
“m” and “n” are any natural numbers.
“e” is the base of a natural logarithm.
“H” is a hash function.
“D” is a set of input data of an inference model.
“x” is input data on which inference processing is to be performed.
“M” is an inference model.

When “n” is a natural number, [n] is a set {1, . . . , n}.
“Z” is a set of integers.
“R” is a set of real numbers.

### Description of Operation

The operation of the inference verification system 100 is equivalent to an inference verification method. A procedure for the operation of the inference verification system 100 is equivalent to a procedure for processing by an inference verification program.

The inference verification program includes the parameter generation program, the key generation program, the inference program, the proving program, and the verification program.

Each program can be recorded (stored) in a computer readable format in a non-volatile recording medium such as an optical disc or a flash memory.

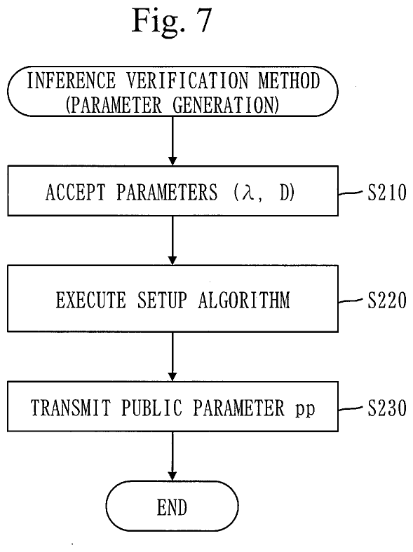

Based on FIG. 7, the operation of the parameter generation device 200 in the inference verification method will be described.

In step S210, the acceptance unit 210 accepts parameters (λ, D) that are input into the parameter generation device 200.

For example, the parameters (λ, D) are input into the parameter generation device 200 by an administrator.

In step S220, the generation unit 220 executes a setup algorithm using as the parameters (λ, D) as input.

This generates a public parameter pp.

The setup algorithm is an algorithm for generating the public parameter pp.

For example, the setup algorithm (Setup) is expressed as indicated below.

$$\begin{matrix}Setup ( {1}^{λ} , D ) : \\ {g}_{i} ← 𝒢 \\ pp := ( {g}_{1} , … , {g}_{n} )\end{matrix} \qquad [ Formula 1 ]$$

In step S230, the output unit 230 outputs the public parameter pp.

Specifically, the output unit 230 transmits the public parameter pp to the key generation device 300.

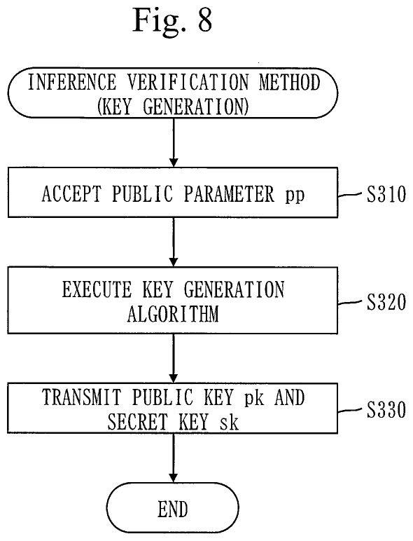

Based on FIG. 8, the operation of the key generation device 300 in the inference verification method will be described.

In step S310, the acceptance unit 310 accepts the public parameter pp that is input into the key generation device 300.

Specifically, the acceptance unit 310 receives the public parameter pp from the parameter generation device 200.

In step S320, the generation unit 320 executes a key generation algorithm using the public parameter pp as input.

This generates a public key pk and a secret key sk.

The key generation algorithm is an algorithm for generating the public key pk and the secret key sk.

For example, the key generation algorithm (Kg) is expressed as indicated below.

$$\begin{matrix}Kg ( pp ) : \\ {h}_{i} ← 𝒢 \\ {s}_{j} ← {Z}_{p} \\ p k := ( {g}_{1} , … , {g}_{n} , {h}_{1} , … , {h}_{m} ) \\ sk := ( {s}_{1} , … , {s}_{l} )\end{matrix} \qquad [ Formula 2 ]$$

In step S330, the output unit 330 outputs the public key pk and the secret key sk.

Specifically, the output unit 330 transmits the public key pk and the secret key sk to the proving device 500. The output unit 330 transmits the public key pk to the verification device 600.

Based on FIG. 4, the operation of the inference device 400 in the inference verification method will be described.

In step S410, the acceptance unit 410 accepts parameters (M, x) that are input into the inference device 400.

For example, an inference model M is input into the inference device 400 by a provider of the inference model M. Data x is transmitted to the inference device 400 by a client.

The inference model M is a model for inference processing.

The data x is data on which inference processing is to be performed.

In step S420, the inference unit 420 executes an inference processing algorithm using the inference model M and the data x as input.

This generates an inference result c.

The inference processing algorithm is an algorithm for generating the inference result c.

For example, the inference processing algorithm (Classify) is expressed as indicated below.

CNN is a convolutional neural network that is executed by the inference model M.

$$\begin{matrix}Classify ( M , x ) : \\ c := CNN ( x )\end{matrix} \qquad [ Formula 3 ]$$

In step S430, the output unit 430 outputs the inference result c.

Specifically, the output unit 430 transmits the inference result c to the proving device 500.

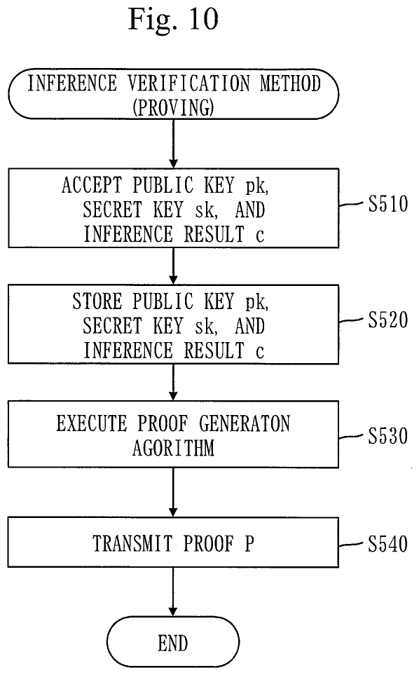

Based on FIG. 10, the operation of the proving device 500 in the inference verification method will be described.

In step S510, the acceptance unit 510 accepts the public key pk, the secret key sk, and the inference result c.

Specifically, the acceptance unit 510 receives the public key pk and the secret key sk from the key generation device 300. The acceptance unit 510 receives the inference result c from the inference device 400.

In step S520, the key storing unit 521 stores the public key pk and the secret key sk.

The inference result storing unit 522 stores the inference result c.

For example, the public key pk, the secret key sk, and the inference result c are stored in the auxiliary storage device 503.

In step S530, the proving unit 530 executes a proof generation algorithm using the public key pk, the secret key sk, and the inference result c as input.

This generates a proof P.

The proof generation algorithm is an algorithm for generating the proof P.

An example of the proof generation algorithm (Prove) will be described below.

The inference result c is expressed as indicated below, where cᵢ is a computation result of the i-th layer of the CNN.

c=c₁, . . . , cₙ

Proveᵢ is an algorithm for generating a proof Pᵢ for the computation result cᵢ.

For example, the proof generation algorithm (Prove) is expressed as indicated below.

$$\begin{matrix}Prove ( p k , s k , c ) : \\ {P}_{1} := {Prove}_{1} ( p k , sk , {c}_{1} ) , … , {P}_{n} := {Prove}_{n} ( p k , sk , {c}_{n} ) \\ P := ( {P}_{1} , … , {P}_{n} )\end{matrix} \qquad [ Formula 4 ]$$

Types (Pₐ to P_{f}) of Proveᵢ are as described below.
(Pₐ) When the i-th layer of the CNN is the ReLU Activation layer, the type of Proveᵢ is Prove_{ReLU}.
(P_{b}) When the i-th layer of the CNN is the Affine layer, the type of Proveᵢ is Prove_{Affine}.
(P_{c}) When the i-th layer of the CNN is the Convolution layer, the type of Proveᵢ is Prove_{conv}.
(P_{d}) When the i-th layer of the CNN is the Average Pooling layer, the type of Proveᵢ is Prove_{AP}.
(Pₑ) When the i-th layer of the CNN is the Max Pooling layer, the type of Proveᵢ is Prove_{MP}.
(P_{f}) When the i-th layer of the CNN is the Soft Max layer, the type of Proveᵢ is Prove_{SoftMax}.

The types (Pₐ to P_{f}) of Proveᵢ will be described later.

In step S540, the output unit 540 outputs the proof P.

Specifically, the output unit 540 transmits the proof P to the verification device 600.

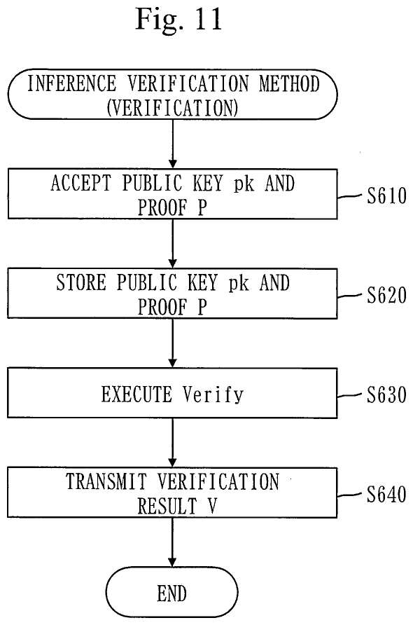

Based on FIG. 11, the operation of the verification device 600 in the inference verification method will be described.

In step S610, the acceptance unit 610 accepts the public key pk and the proof P.

Specifically, the acceptance unit 610 receives the public key pk from the key generation device 300. The acceptance unit 610 receives the proof P from the proving device 500.

In step S620, the key storing unit 621 stores the public key pk.

The proof storing unit 622 stores the proof P.

For example, the public key pk and the proof P are stored in the auxiliary storage device 603.

In step S630, the verification unit 630 executes a verification algorithm using the public key pk and the proof P as input.

This generates a verification result V.

The verification algorithm is an algorithm for generating the verification result V.

An example of the verification algorithm (Verify) will be described below.

Verifyᵢ is an algorithm for verifying a proof Pᵢ.

For example, the verification algorithm (Verify) is expressed as indicated below.

$$\begin{matrix}Verify ( p k , P ) : \\ {V}_{1} := {Verify}_{1} ( p k , {P}_{1} ) , … , {Verify}_{n} ( p k , {P}_{n} ) \\ if ( {V}_{1} ∧ … ∧ {V}_{n} = true ) \\ V := c \\ if ( {V}_{1} ∧ … ∧ {V}_{n} = false \\ V := ⊥\end{matrix} \qquad [ Formula 5 ]$$

Types (Vₐ to V_{f}) of Verify; are as described below.
(Vₐ) When the i-th layer of the CNN is the ReLU Activation layer, the type of Verifyᵢ is Verify_{ReLU}.
(V_{b}) When the i-th layer of the CNN is the Affine layer, the type of Verifyᵢ is Verify_{Affine}.
(V_{c}) When the i-th layer of the CNN is the Convolution layer, the type of Verifyᵢ is Verify_{Conv}.
(V_{d}) When the i-th layer of the CNN is the Average Pooling layer, the type of Verifyᵢ is Verify_{AP}.
(Vₑ) When the i-th layer of the CNN is the Max Pooling layer, the type of Verify₁ is Verify_{MP}.
(V_{f}) When the i-th layer of the CNN is the SoftMax layer, the type of Verifyᵢ is Verify_{SoftMax}.

The types (Vₐ to V_{f}) of Verifyᵢ will be described later.

In step S640, the output unit 640 outputs the verification result V.

For example, the output unit 640 displays the verification result V on a display.

### Description of Protocols and Representation as an Integer Value

With regard to zero-knowledge proof protocols used in Embodiment 1, the following protocols will be described. In addition, representation of a decimal as an integer value in Embodiment 1 will be described.
(1) Schnorr protocol
(2) Schnorr protocol for multiple exponents
(3) Generalized Schnorr protocol
(4) OR Proof protocol
(5) nOR Proof protocol
(6) Representation of a decimal as an integer value
(7) Range Proofs protocol
(8) Multiplication Proofs protocol
(9) The ReLU Layer protocol [Pₐ, Vₐ]
(10) The Affine Layer protocol [P_{b}, V_{b}]
(11) The Convolution Layer protocol [P_{c}, V_{c}]
(12) The Average Pooling Layer protocol [P_{d}, V_{d}]
(13) The Max Pooling Layer protocol [Pₑ, Vₑ]
(14) The SoftMax Layer protocol [P_{f}, V_{f}]

(1) The Schnorr protocol will be described.
“g” is a generator of G. In this case, y=g^{x} holds for x ∈ Zₚ.

The Schnorr protocol is a protocol for proving that a prover knows x in y=g^{x} without providing a verifier with any information about x.

The Schnorr protocol is composed of a proof generation algorithm Prove_{Schnorr} and a verification algorithm Verify_{Schnorr}.

Prove_{Schnorr} outputs the proof P.

$$\begin{matrix}{Prove}_{Schnorr} ( g , y , x ) : \\ r ← {Z}_{p} \\ R := {g}^{r} \\ C := H ( g , y , R ) \\ s := r + Cx \\ P = ( g , y , C , s )\end{matrix} \qquad [ Formula 11 ]$$

Verify_{Schnorr} outputs true or false.

$$\begin{matrix}{Verify}_{S c h n o r r} ( g , y , C , s ) : \\ HV := H ( g , y , {g}^{s} / {y}^{C} ) \\ \begin{matrix}if ( C = HV ) & true\end{matrix} \\ \begin{matrix}if ( C \neq HV ) & false\end{matrix}\end{matrix} \qquad [ Formula 12 ]$$

(2) The Schnorr protocol for multiple exponents will be described. The Schnorr protocol for multiple exponents is obtained by generalizing (1) the Schnorr protocol.

Note that g₁, . . . , gₙ are generators of G. In this case, expression (2A) holds for x₁ ∈ Zₚ, . . . , xₙ ∈ Zₚ.

$$\begin{matrix}[ Formula 13 ] & \\ y = {Π}_{i = 1}^{n} {g}_{i}^{{x}_{i}} & ( 2 A )\end{matrix}$$

The Schnorr protocol for multiple exponents is a protocol for proving that the prover knows (x₁, . . . , xₙ) in expression (2A) without providing the verifier with any information about (x₁, . . . , xₙ).

The Schnorr protocol for multiple exponents is composed of a proof creation algorithm Prove_{MultiSchnorr} and a verification algorithm Verify_{MultiSchnorr}.

Prove_{MultiSchnorr} outputs the proof P.

$$\begin{matrix}{Prove}_{MultiSchnorr} ( {g}_{1} , … , {g}_{n} , y , {x}_{1} , … , {x}_{n} ) : \\ \begin{matrix}{r}_{i} ← {Z}_{p} & ( i ∈ \{ 0 , … , n \} )\end{matrix} \\ R := {Π}_{i = 1}^{n} {g}_{i}^{{r}_{i}} \\ C := H ( {g}_{1} , … , {g}_{n} , y , R ) \\ \begin{matrix}{s}_{i} := {r}_{i} + {Cx}_{i} & ( i ∈ \{ 0 , … , n \} )\end{matrix} \\ P = ( {g}_{1} , … , {g}_{n} , y , C , {s}_{1} , … , {s}_{n} )\end{matrix} \qquad [ Formula 14 ]$$

Verify_{MultiSchnorr} outputs true or false.

$$\begin{matrix}[ Formula 15 ] & \\ {Verify}_{MultiSchnorr} ( {g}_{1} , … , {g}_{n} , y , C , {s}_{1} , … , {s}_{n} ) : HV := H ( {g}_{1} , … , {g}_{n} , y , {\prod }_{i = 1}^{n} {g}_{i}^{{s}_{i}} / {y}^{C} ) if ( C = HV ) true if ( C \neq HV ) false & \end{matrix}$$

(3) The generalized Schnorr protocol will be described. The generalized Schnorr protocol is obtained by generalizing (2) the Schnorr protocol for multiple exponents.

Note that g_{1,1}, . . . , g_{1,n}, g_{2,1}, . . . , g_{m,n} are an mn number of generators of G. In this case, expression (3A) holds for x₁ ∈ Zₚ, . . . , xₙ ∈ Zₚ.

$$\begin{matrix}[ Formula 16 ] & \\ {{∧}_{j = 1}}^{m} ( {\prod }_{i = 1}^{n} {g}_{j , i}^{{x}_{i}} = {y}_{j} ) & ( 3 A )\end{matrix}$$

The generalized Schnorr protocol is a protocol for proving that the prover knows (x₁, . . . , xₙ) in expression (3A) without providing the verifier with any information about (x₁, . . . , xₙ).

The generalized Schnorr protocol is composed of a proof creation algorithm Prove_{GenSchnorr} and a verification algorithm Verify_{Genschnorr}.

Prove_{GenSchnorr} outputs the proof P.

$$\begin{matrix}[ Formula 17 ] & \\ {Prove}_{GenSchnorr} ( {( {g}_{j , i} )}_{j ∈ [ m ] , i ∈ [ n ]} , {( {y}_{i} )}_{j ∈ [ m ]} , {( {x}_{i} )}_{i ∈ [ n ]} ) : {r}_{1} , … , {r}_{n} ← {Z}_{p} , {R}_{1} := {\prod }_{i = 1}^{n} {g}_{1 , i}^{{r}_{i}} , … , {R}_{m} := {\prod }_{i = 1}^{n} {g}_{m , i}^{{r}_{i}} C := H ( {( {g}_{j , i} )}_{j ∈ [ m ] , i ∈ [ n ]} , {( {y}_{j} )}_{j ∈ [ m ]} , {( {R}_{j} )}_{j ∈ [ m ]} ) {s}_{1} := {r}_{1} + C {x}_{1} , … , {s}_{n} := {r}_{n} + C {x}_{n} P := ( {( {g}_{j , i} )}_{j ∈ [ m ] , i ∈ [ n ]} , {( {y}_{j} )}_{j ∈ [ m ]} , C , {s}_{1} , … , {s}_{n} ) & \end{matrix}$$

Verify_{GenSchnorr} outputs true or false.

$$\begin{matrix}[ Formula 18 ] & \\ {Verify}_{GenSchnorr} ( {( {g}_{j , i} )}_{j ∈ [ m ] , i ∈ [ n ]} , {( {y}_{j} )}_{j ∈ [ m ]} , C , {s}_{1} , … , {s}_{n} ) : \\ HV := H ( {( {g}_{j , i} )}_{j ∈ [ m ]} , {( {y}_{j} )}_{j ∈ [ m ]} , {( {\prod }_{i = 1}^{n} {g}_{j , i}^{{s}_{i}} / {y}_{j}^{C} )}_{j ∈ [ m ]} ) \\ if ( C = HV ) true \\ if ( C \neq HV ) false & \end{matrix}$$

(4) The OR Proof protocol will be described.

Note that g_{1,1}, . . . , g_{1,n}, g_{2,1}, . . . , g_{m,n} are an mn number of generators of G. In this case, expression (4A) holds for x=(x₁, . . . , xₙ).

$$\begin{matrix}[ Formula 19 ] & \\ f ( x ) = {( {\prod }_{i = 1}^{n} {g}_{j , i}^{{x}_{i}} )}_{j = 1 , … , m} & ( 4 A )\end{matrix}$$

For i=1, 2, the following expressions hold.

x⁽ⁱ⁾=(x₁⁽ⁱ⁾, . . . , xₙ⁽ⁱ⁾) ∈(Zₚ)ⁿ

y⁽ⁱ⁾=f(x⁽ⁱ⁾)

The OR Proof protocol is a protocol for proving that the prover knows x⁽¹⁾ in y⁽¹⁾=f(x⁽¹⁾) or x⁽²⁾ in y⁽²⁾=f(x⁽²⁾) without providing the verifier with any information about x⁽¹⁾ and x⁽²⁾.

The OR Proof protocol is composed of a proof creation algorithm Prove_{OR} and a verification algorithm Verify_{OR}.

Prove_{OR} outputs the proof P.

$$\begin{matrix}[ Formula 20 ] & \\ {Prove}_{OR} ( {( {g}_{j , i} )}_{j ∈ [ m ] , i ∈ [ n ]} , {( {y}^{( i )} , {x}^{( i )} )}_{i = 1 , 2} ) : j := 3 - i ( i = 1 or 2 ) {s}^{( j )} ← {( {Z}_{p} )}^{n} {C}^{( j )} ← {Z}_{p} {R}^{( j )} := f ( {s}^{( j )} ) / {( {y}^{( j )} )}^{{c}^{( j )}} {r}^{( i )} ← {( {Z}_{p} )}^{n} {R}^{( i )} := f ( {r}^{( i )} ) C := H ( {y}^{( 1 )} , {y}^{( 2 )} , {R}^{( 1 )} , {R}^{( 2 )} ) {C}^{( i )} := C - {C}^{( j )} {s}^{( i )} := {r}^{( i )} + {C}^{( i )} {x}^{( i )} P := ( {( {g}_{j , i} )}_{j ∈ [ m ] , i ∈ [ n ]} , {y}^{( 1 )} , {y}^{( 2 )} , {C}^{( 1 )} , {C}^{( 2 )} , {s}^{( 1 )} , {s}^{( 2 )} ) & \end{matrix}$$

Verify_{OR} outputs true or false.

$$\begin{matrix}[ Formula 21 ] & \\ {Verify}_{OR} ( {( {g}_{j , i} )}_{j ∈ [ m ] , i ∈ [ n ]} , {y}^{( 1 )} , {y}^{( 2 )} , {C}^{( 1 )} , {C}^{( 2 )} , {s}^{( 1 )} , {s}^{( 2 )} ) : HV := H ( {( {g}_{j , i} )}_{j ∈ [ m ] , i ∈ [ n ]} {y}^{( 1 )} , {y}^{( 2 )} , f ( {s}^{( 1 )} ) / {( {y}^{( 1 )} )}^{{c}^{( 1 )}} , f ( {s}^{( 2 )} ) / {( {y}^{( 2 )} )}^{{c}^{( 2 )}} ) if ( {C}^{( 1 )} + {C}^{( 2 )} = HV ) true if ( {C}^{( 1 )} + {c}^{( 2 )} \neq HV ) false & \end{matrix}$$

(5) The nOR Proof protocol will be described. The nOR Proof protocol is obtained by generalizing (4) the OR Proof protocol.

Note that g_{1,1}, . . . , g_{1,n}, g_{2,1}, . . . , g_{m,n} are an mn number of generators of G. In this case, expression (5A) holds for x=(x₁, . . . , xₙ).

$$\begin{matrix}[ Formula 22 ] & \\ f ( x ) = {( {\prod }_{i = 1}^{n} {g}_{j , i}^{{x}_{i}} )}_{j = 1 , … , m} & ( 5 A )\end{matrix}$$

The following expressions hold for i ∈ [n].

x⁽ⁱ⁾=(x₁⁽ⁱ⁾, . . . , xₙ⁽ⁱ⁾) ∈(Zₚ)ⁿ

y⁽ⁱ⁾=f(x⁽ⁱ⁾)

The nOR Proof protocol is a protocol for proving that the prover knows at least one x⁽ⁱ⁾ in y⁽ⁱ⁾=f(x⁽ⁱ⁾) without providing the verifier with any information about each x⁽ⁱ⁾.

The nOR Proof protocol is composed of a proof creation algorithm Proven_{OR} and a verification algorithm Verifyn_{OR}.

Proven_{OR} computes three expressions s(j), C(j), and R(j) for all j ∈ [n]{i}, and outputs the proof P.

$$\begin{matrix}[ Formula 23 ] & \\ {Prove}_{n O R} ( {( {g}_{j , i} )}_{j ∈ [ m ] , i ∈ [ n ]} , {( {y}^{( i )} , {x}^{( i )} )}_{i ∈ [ n ]} ) : {s}^{( j )} ← {( {Z}_{p} )}^{n} {C}^{( j )} ← {Z}_{p} {R}^{( j )} := f ( {s}^{( j )} ) / {( {y}^{( j )} )}^{{c}^{( j )}} {r}^{( i )} ← {( {Z}_{p} )}^{n} {R}^{( i )} := f ( {r}^{( i )} ) C := H ( {( {y}^{( i )} , {R}^{( i )} )}_{i ∈ [ n ]} ) {C}^{( i )} := C - {\sum }_{j ∈ [ n ] ∖ \{ i \}} {C}^{( j )} {s}^{( i )} := {r}^{( i )} + {C}^{( i )} {x}^{( i )} P := ( {( {g}_{j , i} )}_{j ∈ [ m ] , i ∈ [ n ]} , {( {y}^{( i )} , {C}^{( i )} , {s}^{( i )} )}_{i ∈ [ n ]} ) & \end{matrix}$$

Verify_{nOR} outputs true or false.

$$\begin{matrix}[ Formula 24 ] & \\ {Verify}_{nOR} ( {( {g}_{j , i} )}_{j ∈ [ m ] , i ∈ [ n ]} {( {y}^{( i )} , {C}^{( i )} , {s}^{( i )} )}_{i ∈ [ n ]} ) : HV := H ( {( {y}^{( i )} , f ( {s}^{( i )} ) / {( {y}^{( i )} )}^{{c}^{( i )}} )}_{i ∈ [ n ]} ) if ( {C}^{( 1 )} + … + {C}^{( n )} = HV ) true if ( {C}^{( 1 )} + … + {C}^{( n )} \neq HV ) false & \end{matrix}$$

(6) The representation of a decimal as an integer value will be described.

“1” and “d” are positive integers, and expression (6A) holds.

$$\begin{matrix}[ Formula 25 ] & \\ {2}^{2 ( l + d ) + 1} + {2}^{d} \leq ( p - 1 ) / 2 & ( 6 A )\end{matrix}$$

In this case, the fixed-point representation of a decimal x is expressed as an integer <X>.

$$\begin{matrix}[ Formula 26 ] & \\ x = {x}_{0} + {x}_{1} {2}^{- d} ( {x}_{0} ∈ \{ - {2}^{l} , … , {2}^{l} - 1 \} , {x}_{1} ∈ \{ 0 , … , {2}^{d} - 1 \} ) 〈 x 〉 = {x}_{0} {2}^{d} + {x}_{1} ∈ {Z}_{p} & \end{matrix}$$

This allows model parameters of the convolutional neural network, which are usually expressed as real numbers, to be treated as integer values.

(7) The Range Proofs protocol will be described.

“g” and “h” are generators of G.

“t” is an integer.

The Range Proofs protocol is a protocol for proving by the prover that the integer t is an integer equal to or greater than 0 and less than 2^{m} without providing the verifier with information about the integer t.

The Range Proofs protocol is composed of a proof creation algorithm Prove_{Range} and a verification algorithm Verify_{Range}.

Prove_{Range} computes a binary number representation of t.

$$\begin{matrix}[ Formula 27 ] & \\ t = {\sum }_{i = 1}^{m - 1} {2}^{i} {t}_{i} ( {t}_{i} ∈ 0 , 1 ) {s}_{1} ← {Z}_{p} , … , {s}_{m - 1} ← {Z}_{p} {B}_{1} := {g}^{{s}_{1}} {h}^{{t}_{1}} , … , {B}_{m - 1} := {g}^{{s}_{m - 1}} {h}^{{t}_{m - 1}} & \end{matrix}$$

Then, Prove_{Range} calculates the proof P for the following four expressions using Prove_{GenSchnorr} in (3) the generalized Schnorr protocol.

$$\begin{matrix}[ Formula 28 ] & \\ {Prove}_{R ange} ( g , h , t ) : A = {g}^{s} {h}^{t} {B}_{i} = {g}^{{s}_{i}} {h}^{{t}_{i}} ( i ∈ \{ 0 , … , m - 1 \} ) {B}_{i}^{{t}_{i}} / {B}_{i} = {g}^{{s}_{i} {t}_{i} \to {s}_{i}} ( i ∈ \{ 0 , … , m - 1 \} ) A = {g}^{s} {\prod }_{i = 1}^{m - 1} {h}^{{2}^{i}} {t}_{i} & \end{matrix}$$

Verify_{Range} outputs the verification result V.

$$\begin{matrix}[ Formula 29 ] & \\ {Verify}_{Range} ( P ) : V := {Verify}_{GenSchorr} ( P ) & \end{matrix}$$

(8) The Multiplication Proofs protocol will be described.

“g” and “h” are generators of G. In this case, the following expressions hold for integers x, y, and z.

$$〈 x 〉 = {x}_{0} + {x}_{1}^{2 d} \\ 〈 y 〉 = {y}_{0} + {y}_{1}^{2 d} \\ 〈 z 〉 = {z}_{0} + {z}_{1}^{2 d}$$

The Multiplication Proofs protocol is a protocol for proving by the prover that a relationship <z>=<xy> holds for the integers x, y, and z excluding truncation without providing the verifier with information about z, x, and y.

The Multiplication Proofs protocol is composed of a proof creation algorithm Prove_{Mult} and a verification algorithm Verify_{Mult}.

In Prove_{Mult}, the meaning of each symbol is as indicated below.

$${r}_{x} , {r}_{y} , {r}_{z} ← {Z}_{p} w := {x}_{1} {y}_{1} mod {2}^{d} {r}_{w} ← {Z}_{p} {C}_{w} := {g}^{{r}_{w}} {h}^{w} \qquad [ Formula 30 ]$$

Prove_{Mult} calculates the proof P for the following nine expressions using (3) the generalized Schnorr protocol and (7) the Range Proofs protocol.

$${Prove}_{Mult} ( g , h , x , y , z ) : {C}_{x} = {g}^{{r}_{x}} {h}^{〈 x 〉} {C}_{y} = {g}^{{r}_{y}} {h}^{〈 y 〉} 〈 x 〉 ∈ \{ - {2}^{l + d} , … , {2}^{l + d} - 1 \} 〈 y 〉 ∈ \{ - {2}^{l + d} , … , {2}^{l + d} - 1 \} {C}_{z} = {g}^{{r}_{z}} {h}^{〈 z 〉} 〈 z 〉 ∈ \{ - {2}^{l + d} , … , {2}^{l + d} - 1 \} {C}_{w} = {g}^{{r}_{w}} {h}^{〈 w 〉} 〈 w 〉 ∈ \{ - {2}^{l + d} , … , {2}^{l + d} - 1 \} {C}_{x}^{〈 y 〉} / ( {C}_{z}^{{2}^{d}} {h}^{w} ) = {g}^{{r}_{x} 〈 y 〉 - {r}_{z} {2}^{d}} \qquad [ Formula 31 ]$$

Verify_{Mult} outputs the verification result V.

$${Verify}_{Mult} ( P ) : V := {Verify}_{GenSchnorr} ( P ) \qquad [ Formula 32 ]$$

(9) The ReLU Layer protocol will be described.

A ReLU function is a function that is used in the Activation layer of the convolutional neural network.

$$ReLU ( x ) = \{ \begin{matrix}0 & ( x < 0 ) \\ x & ( 0 \leq x )\end{matrix} \qquad [ Formula 33 ]$$

The ReLU Layer protocol is a protocol for proving by the prover that a relation y=ReLU(x) holds for the integers x and y without providing the verifier with information about the integers x and y.

The ReLU Layer protocol is composed of a (Pₐ) proof generation algorithm Prove_{ReLU} and a (Vₐ) verification algorithm Verify_{ReLU}.

In Prove_{ReLU}, the meaning of each symbol is as indicated below.

$$a := 0 {r}_{x} , {r}_{y} , {r}_{a} , {r}_{neg} ← {Z}_{p} {C}_{neg} := {g}^{{r}_{neg}} {h}^{〈 a x 〉} \qquad [ Formula 34 ]$$

Prove_{ReLU} calculates the proof P for the following expressions using (4) the OR proof protocol, (7) the Range Proof protocol, and (8) the Multiplication Proofs protocol.

$${Prove}_{ReLU} ( g , h , x , y ) {C}_{x} = {g}^{{r}_{x}} {h}^{〈 x 〉} 〈 x 〉 ∈ \{ - {2}^{l + d} , … , {2}^{l + d} - 1 \} {C}_{y} = {g}^{{r}_{y}} {h}^{〈 y 〉} 〈 y 〉 ∈ \{ - {2}^{l + d} , … , {2}^{l + d} - 1 \} {C}_{a} = {g}^{{r}_{a}} {h}^{〈 a 〉} 〈 a 〉 ∈ \{ - {2}^{l + d} , … , {2}^{l + d} - 1 \} 〈 a x 〉 = 〈 a 〉 〈 x 〉 \qquad [ Formula 35 ]$$

The proof P proves that one of the following two expressions holds.

$$〈 x 〉 ∈ \{ - {2}^{l + d} , … , {2}^{l + d} - 1 \} ∧ {C}_{neg} / {C}_{y} = {g}^{δ} 〈 x 〉 ∈ \{ 0 , … , {2}^{l + d} - 1 \} ∧ {C}_{x} / {C}_{y} = {g}^{δ} \qquad [ Formula 36 ]$$

Verify_{ReLU} outputs the verification result V

$${Verify}_{ReLU} ( P ) : V := {Verify}_{OR} ( P ) \qquad [ Formula 37 ]$$

(10) The Affine Layer protocol will be described.

The Affine Layer protocol is a protocol for proving by the prover that y=Ax+b holds for A ∈ R^{n×n}, b ∈ Rⁿ, and x, y ∈ Rⁿ without providing the verifier with information about x, y, A, and b.

A, b, x, and y are as indicated below.

$$A = ( \begin{matrix}{a}_{1 , 1} & … & {a}_{1 , n} \\ ⋮ & ⋱ & ⋮ \\ {a}_{n , 1} & … & {a}_{n , n}\end{matrix} ) , b = ( {b}_{1} , … , {b}_{n} ) , x = ( {x}_{1} , … , {x}_{n} ) , y = ( {y}_{1} , … , {y}_{n} ) \qquad [ Formula 38 ]$$

The Affine Layer Protocol is composed of a (P_{b}) proof generation algorithm Prove_{Affine} and a (V_{b}) verification algorithm Verify_{Affine}.

In Prove_{Affine}, the meaning of each symbol is as indicated below.

$${r}_{{a}_{i , j}} , {r}_{{x}_{i}} , {r}_{{y}_{i}} , {r}_{i , j} , {r}_{{b}_{i}} ← {Z}_{p} ( ( i , j ) ∈ [ n ] \times [ n ] ) \\ {C}_{i , j}^{′} := {g}^{{r}_{i , j}} {h}^{〈 {a}_{i} {x}_{j} 〉} ( ( i , j ) ∈ [ n ] \times [ n ] ) \qquad [ Formula 39 ]$$

Prove_{Affine} calculates the proof P for the following expressions using (3) the generalized Schnorr protocol, (7) the Range Proofs protocol, and (8) the Multiplication Proofs protocol.

$${Prove}_{Affine} ( g , h , x , y , b , A ) : {C}_{{a}_{i , j}} = {g}^{{r}_{{a}_{i , j}}} {h}^{〈 {a}_{i , j} 〉} ( ( i , j ) ∈ [ n ] \times [ n ] ) , 〈 {a}_{i , j} 〉 ∈ \{ - {2}^{l + d} , … , {2}^{l + d} - 1 \} ( ( i , j ) ∈ [ n ] \times [ n ] ) , {C}_{{b}_{i}} = {g}^{{r}_{{b}_{i}}} {h}^{〈 {b}_{i} 〉} ( i ∈ [ n ] ) , 〈 {b}_{i} 〉 ∈ \{ - {2}^{l + d} , … , {2}^{l + d} - 1 \} ( i ∈ [ n ] ) , {C}_{{x}_{i}} = {g}^{{r}_{{x}_{i}}} {h}^{〈 {x}_{i} 〉} ( i ∈ [ n ] ) , 〈 {x}_{i} 〉 ∈ \{ - {2}^{l + d} , … , {2}^{l + d} - 1 \} ( i ∈ [ n ] ) , {C}_{{y}_{i}} = {g}^{{r}_{{y}_{i}}} {h}^{〈 {y}_{i} 〉} ( i ∈ [ n ] ) , 〈 {y}_{i} 〉 ∈ \{ - {2}^{l + d} , … , {2}^{l + d} - 1 \} ( i ∈ [ n ] ) , 〈 {a}_{i , j} {x}_{i} 〉 = 〈 {a}_{i , j} 〉 〈 {x}_{i} 〉 ( ( i , j ) ∈ [ n ] \times [ n ] ) , {C}_{{y}_{i}} / ( {\prod }_{j = 1}^{n} {C}_{i , j}^{′} ) {C}_{{b}_{i}} = {g}^{{δ}_{i}} ( i ∈ [ n ] ) . \qquad [ Formula 40 ]$$

Verify_{Affine} outputs the verification result V.

$${Verify}_{ReLU} ( P ) : V := {Verify}_{GenShnorr} ( P ) \qquad [ Formula 41 ]$$

(11) The Convolution Layer protocol will be described.

The Convolution Layer protocol is a protocol for proving by the prover that y=Conv(x) holds for x, y ∈ R^{mm′} without providing the verifier with information about x, y, and Conv.

Conv is an operation that is performed on input data x in the Convolution layer of the convolutional neural network.

The Convolution Layer protocol is composed of a (P_{c}) proof generation algorithm Prove_{Conv} and a (V_{c}) verification algorithm Verify_{Conv}.

(a_{i,j}) is a weight parameter of Conv. In this case, for input x=(x_{1,1}, . . . x_{1,m′}, . . . , x_{m,1}, . . . , x_{m,m′}) and output y=(y_{1,1}, . . . , y_{1,m′}, . . . ,y_{m, 1}, . . . , y_{m,m′}), y_{i,j} can be expressed as the following expression.

$${y}_{i , j} = {\sum }_{{i}^{′} = 0}^{s - 1} {\sum }_{{j}^{′} = 0}^{t - 1} {a}_{i , j} {x}_{i + {i}^{′} , j + {j}^{′}} ( 1 \leq i \leq m - s + 1 , 1 \leq j \leq {m}^{′} - t + 1 ) \qquad [ Formula 42 ]$$

Therefore, the proof P and the verification result V can be generated in a similar manner to that of (10) the Affine Layer protocol.

$${Prove}_{Co𝔫v} ( g , h , x , y , b , A ) : P := {Prove}_{Affinev} ( g , h , x , y , b , A ) {Verify}_{C o n v} ( P ) V := {Verify}_{Affine} ( P ) \qquad [ Formula 43 ]$$

(12) The Average Pooling Layer protocol will be described.

The Average Pooling Layer protocol is a protocol for proving by the prover that y=AP(x) holds for x, y ∈ R^{m×m} without providing the verifier with information about x, y, and AP.

AP is an operation that is performed on input data x in the Average Pooling layer of the convolutional neural network.

The Average Pooling Layer protocol is composed of a (P_{d}) proof generation algorithm Prove_{AP} and a (V_{d}) verification algorithm Verify_{AP}.

For y and x, the following relationship holds.

“1” is the size of rows and columns and a stride in an AP filter.

$$x = ( \begin{matrix}{x}_{1 , 1} & … & {x}_{1 , m} \\ ⋮ & ⋱ & ⋮ \\ {x}_{m , 1} & … & {x}_{m , m}\end{matrix} ) , y = ( \begin{matrix}{y}_{1 , 1} & … & {y}_{1 , m} \\ ⋮ & ⋱ & ⋮ \\ {y}_{m , 1} & … & {y}_{m , m}\end{matrix} ) \qquad [ Formula 44 ]$$

$${y}_{i , j} = {\sum }_{s = 0}^{l - 1} {\sum }_{t = 0}^{l - 1} \frac{1}{{l}^{2}} {x}_{( {l}_{i} + s - 1 ) , ( {l}_{j} + t - 1 )}$$

$$( 1 \leq i \leq \sqrt{m} , 1 \leq j \leq \sqrt{m} ) .$$

Therefore, y can be expressed as a linear transformation of x.

Therefore, the proof P and the verification result V can be generated in a similar manner to (10) the Affine Layer protocol.

$${Prove}_{AP} ( g , h , x , y , l ) : \qquad [ Formula 45 ]$$

$$P := {Prove}_{Affinev} ( g , h , x , y , l )$$

$${Verify}_{AP} ( P ) :$$

$$V := {Verify}_{Affine} ( P )$$

(13) The Max Pooling Layer protocol will be described.

The Max Pooling Layer protocol is a protocol for proving by the prover that y=MP(x) holds for x ∈ R^{km×km} and y ∈ R^{m×m} without providing the verifier with information about x, y, and MP.

MP is an operation that is performed on input data x in the Max Pooling layer of the convolutional neural network.

The Max Pooling Layer protocol is composed of a (Pₑ) proof generation algorithm Prove_{MP} and a (Vₑ) verification algorithm Verify_{MP}.

For y and x, the following relationship holds.

“k” is the size of rows and columns and a stride in an MP filter.

$$x = ( \begin{matrix}{x}_{1 , 1} & … & {x}_{1 , k m} \\ ⋮ & ⋱ & ⋮ \\ {x}_{k m , 1} & … & {x}_{k m , k m}\end{matrix} ) , y = ( \begin{matrix}{y}_{1 , 1} & … & {y}_{1 , m} \\ ⋮ & ⋱ & ⋮ \\ {y}_{m , 1} & … & {y}_{m , m}\end{matrix} ) \qquad [ Formula 46 ]$$

$${y}_{i , j} = max \{ {x}_{k ( i - 1 ) + s , k ( j - 1 ) + t} \vert s , t , ∈ [ 1 , k ] \} .$$

In order to prove that this relationship holds, it is proved that the following expression holds.

$${⋀}_{s = 0}^{k} {⋀}_{t = 0}^{k} ( {y}_{i , j} \geq {x}_{k ( i - 1 ) + s , k ( j - 1 ) + t} ) ∧ {⋁}_{s = 0}^{k} {⋁}_{t = 0}^{k} ( {y}_{i , j} = {x}_{k ( i - 1 ) + s , k ( j - 1 ) + t} ) . \qquad [ Formula 47 ]$$

Prove_{MP} performs the following computation for all (i, j) ∈ [m]×[m].

$${Prove}_{MP} ( g , h , x , y , k ) : \qquad [ Formula 48 ]$$

$${r}_{k ( i - 1 ) + s , k ( j - 1 ) + t} ← {Z}_{p} ( s , t ) ∈ [ k ] \times [ k ]$$

$${r}_{i , j}^{′} ← {Z}_{p}$$

$${C}_{k ( i - 1 ) + s , k ( j - 1 ) + t} := {g}^{{r}_{k ( i - 1 ) + s , k ( j - 1 ) + t}} {h}^{〈 {x}_{k ( i - 1 ) + s , k ( j - 1 ) + t} 〉} ( s , t ) ∈ [ k ] \times [ k ]$$

$${C}_{i , j}^{′} := {g}^{{r}_{i , j}^{′}} {h}^{〈 {y}_{i , j} 〉}$$

Prove_{MP} calculates the proof P for the following formula using (7) the Range Proofs protocol and the nOR Proof protocol.

$$〈 {y}_{i , j} 〉 - 〈 {x}_{k ( i - 1 ) + s , k ( j - 1 ) + t} 〉 ∈ \{ 0 , … , {2}^{l + d + 1} - 1 \} ( s , t ) ∈ [ k ] \times [ k ] \qquad [ Formula 49 ]$$

$${⋁}_{( s , t ) ∈ [ k ] \times [ k ]} {C}_{k ( i - 1 ) + s , k ( j - 1 ) + t} / {C}_{i , j}^{′}$$

$${C}_{i , j}^{′} = δ s , t ( {δ}_{s , t} = {r}_{k ( i - 1 ) + s , k ( j - 1 ) + t} - {r}_{i , j}^{′} )$$

Verify_{MP} generates the verification result V using Verify_{nOR}.

$${Verify}_{MP} ( P ) : \qquad [ Formula 50 ]$$

$$V := {Verify}_{nOR} ( P )$$

(14) The SoftMax Layer protocol will be described.

The SoftMax Layer protocol is a protocol for proving by the prover that y=SoftMax(x) holds for x, y ∈ Rⁿ without providing the verifier with information about x and y.

SoftMax is an operation that is performed on input data x in the SoftMax layer of the convolutional neural network.

For x=(x₁, . . . , xₙ) and y=(y₁, . . . , yₙ), yᵢ is expressed as expression (13A).

$$\begin{matrix}[ Formula 51 ] & \\ {y}_{i} = {e}^{{x}_{i}} / {\sum }_{j = 1}^{n} {e}^{{x}_{j}} & ( 13 A )\end{matrix}$$

The SoftMax Layer protocol performs computation by replacing the input x with x′=log₂e^{x}.

Therefore, a proof for expression (13A) can be constructed as described below. A protocol for proving that y′=2x‘ holds for x’, y′ ∈ R is constructed. By combining this protocol with (8) the Multiplication Proofs protocol, the proof can be constructed.

The protocol for proving that y′=2^{x′} holds is composed of a proof generation algorithm Proveₑₓₚ and a verification result generation algorithm Verifyₑₓₚ.

<x′>=x₀′2^{d}+x₁′ holds. This protocol computes expression (13D) using polynomial with degree 8 (13C) instead of computing expression (13B).

$$\begin{matrix}[ Formula 52 ] & \\ {2}^{{x}_{0}^{′} + {x}_{1}^{′} / {2}^{d}} = {2}^{{x}_{0}^{′}} {2}^{{x}_{1}^{′} / {2}^{d}} & ( 13 B )\end{matrix}$$

$${P}_{1045} ( X ) = {c}_{8} {X}^{8} + … + {c}_{0} \qquad ( 13 C )$$

$${2}^{{x}_{1}^{′}} {P}_{1045} ( {x}_{0}^{′} ) \qquad ( 13 D )$$

Note that c₀ to c₈ are as indicated below.

$${c}_{0} = 0.100000000000077443021686 \cdot {10}^{1} \qquad [ Formula 53 ]$$

$${c}_{1} = 0.693147180426163827795756 \cdot {10}^{0}$$

$${c}_{2} = 0.24022651071017064605384 \cdot {10}^{0}$$

$${c}_{3} = 0.55504068620466379157744 \cdot {10}^{- 1}$$

$${c}_{4} = 0.9618341225880462374977 \cdot {10}^{- 2}$$

$${c}_{5} = 0.1332730359281437819329 \cdot {10}^{- 2}$$

$${c}_{6} = 0.155107460590052573978 \cdot {10}^{- 3}$$

$${c}_{7} = 0.14197847399765606711 \cdot {10}^{- 4}$$

$${c}_{8} = 0.1863347724137967076 \cdot {10}^{- 5}$$

The proof generation algorithm Proveₑₓₚ is indicated below.

Note that x₀′[i] is the i-th bit of x₀′.

$${Prove}_{exp} ( g , h , {x}^{′} ) : \qquad [ Formula 54 ]$$

$${z}_{1} := 〈 {x}_{1}^{′1} 〉 , … , {z}_{g} := 〈 {x}_{1}^{′ 8} 〉 ,$$

$$u := 〈 {2}^{{x}_{0}^{′}} 〉 ,$$

$$d := 〈 {P}_{1045} ( {x}_{1}^{′} ) 〉 ,$$

$${r}_{int} , {r}_{int}^{( 0 )} , … , {r}_{int}^{( l - 1 )} , {r}_{real} , {r}_{real}^{( 2 )} , … , {r}_{real}^{( 8 )} , {r}_{d} , {r}_{u} ← {Z}_{p} ,$$

Proveₑₓₚ creates the proof P for the following expressions using (7) the Range Proofs protocol, (8) the Multiplication Proofs protocol, and (3) the generalized Schnorr protocol.

$${C}_{int} = {g}^{{r}_{int}} {h}^{{x}_{0}^{′}} ,$$

$${C}_{int}^{( i )} = {g}^{{r}_{int}^{( i )}} {h}^{{x}_{0}^{′} [ i ]} i ∈ \{ 0 , … , l - 1 \} ,$$

$${C}_{real} = {g}^{{r}_{real}} {h}^{〈 {x}_{1}^{′} 〉} ,$$

$${C}_{real}^{( i )} = {g}^{{r}_{real}^{( i )}} {h}^{{z}_{i}} i ∈ \{ 2 , … , 8 \} ,$$

$${C}_{d} = {g}^{{r}_{d}} {h}^{d} ,$$

$${C}_{u} = {g}^{{r}_{u}} {h}^{u} ,$$

$$〈 {x}_{0}^{′} 〉 ∈ \{ {2}^{d} , … , {2}^{d + l - 1} \} , 〈 {x}_{1}^{′} 〉 ∈ \{ 0 , … , {2}^{d} - 1 \} , 〈 {x}^{′} 〉 = 〈 {x}_{0}^{′} 〉 + 〈 {x}_{1}^{′} 〉 ,$$

$${x}_{1} = {\prod }_{i = 0}^{l - 1} {x}_{1}^{′} [ i ] \cdot {2}^{i} ,$$

$$u = {\prod }_{i = 0}^{l - 1} ( {x}_{1}^{′} [ i ] \cdot {2}^{{2}^{i}} + 1 - {x}_{1}^{′} [ i ] ) ,$$

$${z}_{i} = {z}_{i - 1} \cdot 〈 {x}_{i}^{′} 〉 , {z}_{1} = 〈 {x}_{0}^{′} 〉 i ∈ \{ 2 , … , 8 \} ,$$

$$d = {c}_{8} \cdot {z}_{8} + … + {c}_{0} = 〈 {P}_{1045} ( {x}_{0}^{′} ) 〉 ,$$

$$〈 y 〉 = 〈 u 〉 \cdot 〈 d 〉 .$$

The verification algorithm Verifyₑₓₚ is indicated below.

$${Verify}_{exp} ( P ) : \qquad [ Formula 56 ]$$

$$V := {Verify}_{GenShnorr} ( P )$$

The SoftMax Layer protocol is composed of a (P_{f}) proof generation algorithm Prove_{SoftMax} and a (V_{f}) verification algorithm Verify_{SoftMax}.

Prove_{SoftMax} calculates the proof P for the following expressions using Proveₑₓₚ and Prove_{Mult}.

$${Prove}_{SoftMax} ( g , h , x , y ) : \qquad [ Formula 57 ]$$

$${y}_{i}^{′} = {2}^{{x}_{i}^{′}} i ∈ \{ 1 , … , n \} ,$$

$${y}_{i} = {y}_{i}^{′} / {\sum }_{j = 1}^{n} {y}_{j}^{′} .$$

Verify_{SoftMax} outputs the verification result V.

$${Verify}_{SoftMax} ( P ) : \qquad [ Formula 58 ]$$

$$V := {Verify}_{GenShnorr} ( P )$$

### Features of Embodiment 1

Embodiment 1 has the following features.

Embodiment 1 converts model parameters of an inference model into integer values and verifies the inference model.

The algorithms of the zero-knowledge proof protocols of the respective layers are features of Embodiment 1.

The verification method of the inference model is realized by combining conversion of weight parameters (model parameters) into integer values and the zero-knowledge proof protocols.

The features of Embodiment 1 will be presented with reference sings indicated in parentheses.

An inference device (400) obtains an inference result (c) by executing an inference model (M) by expressing a decimal value that is data (x) on which inference processing is to be performed as an integer value and treating the integer value as a parameter of a convolutional neural network.

A proving device (500) obtains a proof (P) by executing a proof generation algorithm using the inference result as input.

A verification device (600) obtains a verification result (V) by executing a verification algorithm using the proof as input.

The inference result includes a computation result of each layer of the convolutional neural network.

For each layer of the convolutional neural network, the proving device (500) executes the proof generation algorithm of a protocol corresponding to the type of the layer, using the computation result of the layer as input.

The proof includes the execution result of the proof generation algorithm for each layer of the convolutional neural network.

For each layer of the convolutional neural network, the verification device (600) executes the verification algorithm of the protocol corresponding to the type of the layer, using the execution result of the layer as input.

The verification result includes the execution result of the verification algorithm for each layer of the convolutional neural network.

### Effects of Embodiment 1

Embodiment 1 realizes zero-knowledge proof protocols that can handle decimal parameters by representing fixed-point representations of decimals as integer values.

This makes it possible to verify an inference model whose parameters are decimals.

Embodiment 1 has, for example, the following effects.

Data is analyzed by a third party. The third party provides an inference service using a machine learning model.

Embodiment 1 makes it possible to prove that an inference result for the analyzed data is a result obtained by actually performing inference on the data using the machine learning model without disclosing information about an inference model.

The method of Embodiment 1 represents fixed-point representations of decimals as integer values, and uses zero-knowledge proofs using the difficulty of the discrete logarithm problem. This realizes zero-knowledge proof protocols that can handle decimal parameters. Then, it is possible to verify an inference model whose parameters are decimals.

### Supplement to Embodiment 1

The parameter generation device 200, the key generation device 300, the inference device 400, and the proving device 500 may be combined with each other. That is, the inference verification system 100 may include one or more computers that function as the parameter generation device 200, the key generation device 300, the inference device 400, and the proving device 500.

The generation unit 220 of the parameter generation device 200 may include a random number generation function or the like for generating the public parameter pp.

The generation unit 320 of the key generation device 300 may include a random number generation function or the like for generating the public key pk and the secret key sk.

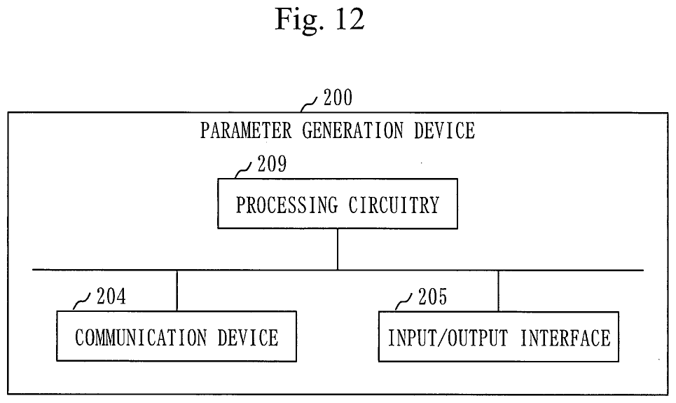

Based on FIG. 12, a hardware configuration of the parameter generation device 200 will be described.

The parameter generation device 200 includes processing circuitry 209.

The processing circuitry 209 is the processing circuitry that realizes the acceptance unit 210, the generation unit 220, and the output unit 230.

The processing circuitry may be dedicated hardware, or may be a processor that executes programs stored in a memory.

When the processing circuitry is dedicated hardware, the processing circuitry is, for example, a single circuit, a composite circuit, a programmed processor, a parallel-programmed processor, an ASIC, an FPGA, or a combination of these.

ASIC is an abbreviation for application specific integrated circuit.

FPGA is an abbreviation for field programmable gate array.

The parameter generation device 200 may include a plurality of processing circuits as an alternative to the processing circuitry 209.

In the processing circuitry 209, some functions may be realized by dedicated hardware and the remaining functions may be realized by software or firmware.

As described above, the functions of the parameter generation device 200 can be realized by hardware, software, firmware, or a combination of these.

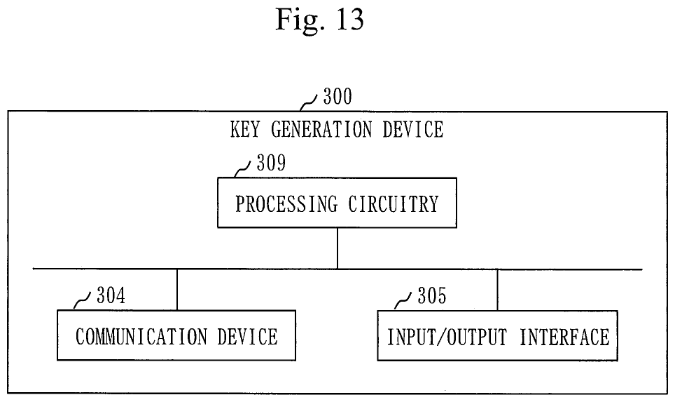

Based on FIG. 13, a hardware configuration of the key generation device 300 will be described.

The key generation device 300 includes processing circuitry 309.

The processing circuitry 309 is the processing circuitry that realizes the acceptance unit 310, the generation unit 320, and the output unit 330.

The key generation device 300 may include a plurality of processing circuits as an alternative to the processing circuitry 309.

In the processing circuitry 309, some functions may be realized by dedicated hardware and the remaining functions may be realized by software or firmware.

As described above, the functions of the key generation device 300 can be realized by hardware, software, firmware, or a combination of these.

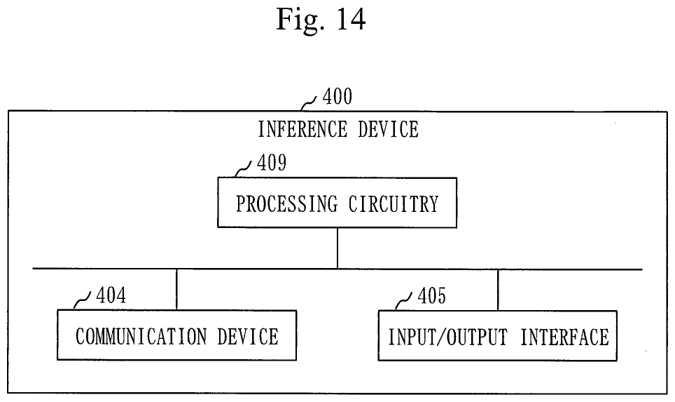

Based on FIG. 14, a hardware configuration of the inference device 400 will be described.

The inference device 400 includes processing circuitry 409.

The processing circuitry 409 is the processing circuitry that realizes the acceptance unit 410, the inference unit 420, and the output unit 430.

The inference device 400 may include a plurality of processing circuits as an alternative to the processing circuitry 409.

In the processing circuitry 409, some functions may be realized by dedicated hardware and the remaining functions may be realized by software or firmware.

As described above, the functions of the inference device 400 can be realized by hardware, software, firmware, or a combination of these.

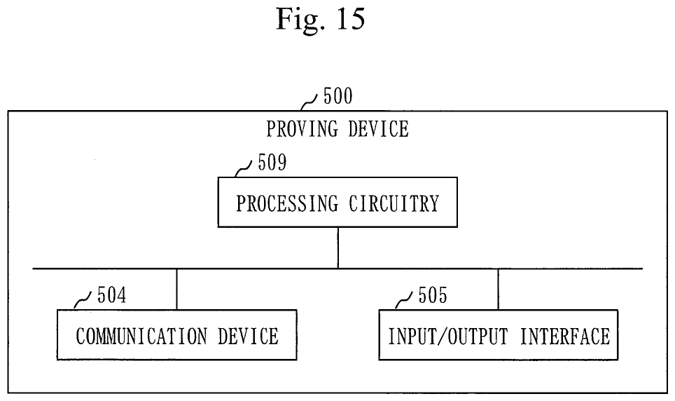

Based on FIG. 15, a hardware configuration of the proving device 500 will be described.

The proving device 500 includes processing circuitry 509.

The processing circuitry 509 is the processing circuitry that realizes the acceptance unit 510, the storing unit 520, the proving unit 530, and the output unit 540.

The proving device 500 may include a plurality of processing circuits as an alternative to the processing circuitry 509.

In the processing circuitry 509, some functions may be realized by dedicated hardware and the remaining functions may be realized by software or firmware.

As described above, the functions of the proving device 500 can be realized by hardware, software, firmware, or a combination of these.

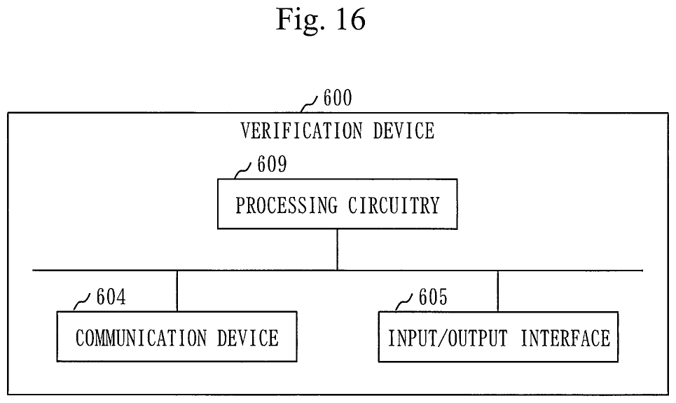

Based on FIG. 16, a hardware configuration of the verification device 600 will be described.

The verification device 600 includes processing circuitry 609.

The processing circuitry 609 is the processing circuitry that realizes the acceptance unit 610, the storing unit 620, the verification unit 630, and the output unit 640.

The verification device 600 may include a plurality of processing circuits as an alternative to the processing circuitry 609.

In the processing circuitry 609, some functions may be realized by dedicated hardware and the remaining functions may be realized by software or firmware.

As described above, the functions of the verification device 600 can be realized by hardware, software, firmware, or a combination of these.

Embodiment 1 is an example of a preferred embodiment, and is not intended to limit the technical scope of the present disclosure. Embodiment 1 may be partially implemented or may be implemented in combination with another embodiment. The procedures described using flowcharts or the like may be suitably changed.

Each “unit” that is an element of the inference verification system 100 may be interpreted as “process”, “step”, “circuit”, or “circuitry”.

### REFERENCE SIGNS LIST

100: inference verification system, 200: parameter generation device, 201: processor, 202: memory, 203: auxiliary storage device, 204: communication device, 205: input/output interface, 209: processing circuitry, 210: acceptance unit, 220: generation unit, 230: output unit, 290: storage unit, 300: key generation device, 301: processor, 302: memory, 303: auxiliary storage device, 304: communication device, 305: input/output interface, 309: processing circuitry, 310: acceptance unit, 320: generation unit, 330: output unit, 390: storage unit, 400: inference device, 401: processor, 402: memory, 403: auxiliary storage device, 404: communication device, 405: input/output interface, 409: processing circuitry, 410: acceptance unit, 420: inference unit, 430: output unit, 490: storage unit, 500: proving device, 501: processor, 502: memory, 503: auxiliary storage device, 504: communication device, 505: input/output interface, 509: processing circuitry, 510: acceptance unit, 520: storing unit, 521: key storing unit, 522: inference result storing unit, 530: proving unit, 540: output unit, 590: storage unit, 600: verification device, 601: processor, 602: memory, 603: auxiliary storage device, 604: communication device, 605: input/output interface, 609: processing circuitry, 610: acceptance unit, 620: storing unit, 621: key storing unit, 622: proof storing unit, 630: verification unit, 640: output unit, 690: storage unit, c: inference result, D: parameter, M: inference model, P: proof, pk: public key, pp: public parameter, sk: secret key, V: verification result, x: data, a: parameter.

1. An inference verification system comprising
processing circuitry to:
obtain an inference result by executing an inference model by expressing a decimal value that is data on which inference processing is to be performed as an integer value and treating the integer value as a parameter of a convolutional neural network, the inference result including a computation result of each layer of the convolutional neural network;
obtain a proof by executing, for each layer of the convolutional neural network, a proof generation algorithm of a protocol corresponding to a type of the layer using the computation result of the layer as input, the proof including an execution result of the proof generation algorithm for each layer of the convolutional neural network; and
obtain a verification result by executing, for each layer of the convolutional neural network, a verification algorithm of the protocol corresponding to the type of the layer using the execution result of the layer as input, the verification result including an execution result of the verification algorithm for each layer of the convolutional neural network.

2. The inference verification system according to claim 1,
wherein a ReLU Layer protocol is protocol corresponding to a ReLU Activation layer of the convolutional neural network.

3. The inference verification system according to claim 1,
wherein an Affine Layer protocol is the protocol corresponding to an Affine layer of the convolutional neural network.

4. The inference verification system according to claim 1,
wherein a Convolution Layer protocol is the protocol corresponding to a Convolution layer of the convolutional neural network.

5. The inference verification system according to claim 1,
wherein an Average Pooling Layer protocol is the protocol corresponding to an Average Pooling layer of the convolutional neural network.

6. The inference verification system according to claim 1,
wherein a Max Pooling Layer protocol is the protocol corresponding to a Max Pooling layer of the convolutional neural network.

7. The inference verification system according to claim 1,
wherein a SoftMax Layer protocol is the protocol corresponding to a SoftMax layer of the convolutional neural network.

8. An inference verification method comprising:
obtaining an inference result by executing an inference model by expressing a decimal value that is data on which inference processing is to be performed as an integer value and treating the integer value as a parameter of a convolutional neural network, the inference result including a computation result of each layer of the convolutional neural network;
obtaining a proof by executing, for each layer of the convolutional neural network, a proof generation algorithm of a protocol corresponding to a type of the layer using the computation result of the layer as input, the proof including an execution result of the proof generation algorithm for each layer of the convolutional neural network; and
obtaining a verification result by executing, for each layer of the convolutional neural network, a verification algorithm of the protocol corresponding to the type of the layer using the execution result of the layer as input, the verification result including an execution result of the verification algorithm for each layer of the convolutional neural network.
